(19) United States
(12) Patent Application Publication
(10) Pub. No.: US 2025/0389864 A1
(43) Pub. Date: Dec. 25, 2025

(54) SYSTEMS AND METHODS FOR FACIES-CONTROLLED CARBON STORAGE

(71) Applicant: SAUDI ARABIAN OIL COMPANY, Dhahran (SA)

(72) Inventors: Sylvester EGBENI, Dhahran (SA); Ahmed AL GHAMDI, Dhahran (SA); Daniel G. SHAUKRY, Dhahran (SA); Sara JAZZAR, Dhahran (SA); Moaath ALGHAMDI, Dhahran (SA)

(73) Assignee: SAUDI ARABIAN OIL COMPANY, Dhahran (SA)

(21) Appl. No.: 18/751,483

(22) Filed: Jun. 24, 2024

(51) Int. Cl. G01V 20/00

(52) U.S. Cl. CPC G01V 20/00

(57) ABSTRACT

Aspects of the present disclose provide methods and devices for selecting a facies-controlled carbon storage reservoir. The method may include constructing one or more facies models based on the at least a reservoir profile and a geological profile, refining the one or more facies models based on the facies map to output one or more refined facies models, constructing one or more pore space models, comparing the one or more pore space models and the one or more refined facies models to the at least the reservoir profile and the geological profile to produce a seal map, a risk map, and a set of storage information, and identifying, based on at least one of the seal map, the risk map, and the set of storage information, a targeted location within the targeted formation, the targeted location having a set of controlling facies capable of containing supercritical carbon dioxide (CO₂).

### FIELD OF THE DISCLOSURE

The present disclosure relates generally to carbon sequestration and storage technology and, more particularly, to methods and systems for constructing carbon trapping mechanisms for carbon dioxide (CO₂) sequestration in facies-controlled reservoirs.

### BACKGROUND OF THE DISCLOSURE

As concerns over climate change continue to increase, there is growing interest in mitigating the effects of industrial processes, such as cement and steel production, and combustion processes utilizing fossil fuels. Carbon Capture and Storage (CCS) is one approach that has been suggested for mitigating the effects of carbon dioxide and other greenhouse gases. CCS delivers captured greenhouse gases to a subterranean storage formation (e.g., a geological storage formation) for short-to long-term storage. Thus, CCS enables continued industrial operation while emitting fewer greenhouse gases (CHGs) by mitigating the presence of CO₂ that would otherwise escape to the atmosphere. Formations targeted for CCS operations may occur in both onshore and offshore settings and may each present a unique set of sequestration challenges. Ideally, formations targeted for carbon storage operations are effective to permanently sequester CO₂, environmentally sustainable, voluminous, and cost-effective. Typically, formations targeted for carbon storage operations are geological saline formations. Saline formations are porous formations that span large volumes deep underground.

Although current techniques for CCS, and for carbon sequestration in particular, are based on technological advancements made over many years, current carbon sequestration technology may still be ineffective to achieve ideal sequestration results. For example, carbon sequestration in open saline formations may be impermanent and environmentally tenuous, while carbon sequestration in closed saline formations may be costly and difficult to achieve on a large scale. As a result, implementation of CCS technologies may be hindered consequently reducing CGH mitigation. Accordingly, there is an impetus to improve current carbon sequestration technology to improve sequestration results, including, for example: reducing or otherwise controlling the atmospheric release of carbon into the atmosphere after sequestration procedures, reducing the environmental impact of carbon sequestration procedures, increasing the storage capacity and efficiency in a variety of target sequestration formations, increasing the throughput of carbon injection into a target formation, decreasing the cost of carbon sequestration, improving the characterization of a target formation for optimal carbon sequestration, reducing the cost and inefficiency associated with closed saline formation carbon storage, and the like.

Consequently, there exists a need for further improvements in carbon sequestration technology to overcome the aforementioned technical challenges and other challenges not mentioned.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for carbon storage may include one or more steps. The steps may include constructing, based on a set of facies at the targeted formation, one or more facies models based on the at least a reservoir profile and a geological profile. The steps may include refining the one or more facies models based on a facies map to output one or more refined facies models. The steps may include constructing, based on the one or more refined facies models, one or more pore space models. The steps may include comparing the one or more pore space models and the one or more refined facies models to the at least the reservoir profile and the geological profile to produce a seal map, a risk map, and a set of storage information. The steps may include identifying, based on at least one of the seal map, the risk map, and the set of storage information, a targeted location within the targeted formation, the targeted location having a set of controlling facies capable of containing supercritical carbon dioxide (CO₂).

In another embodiment consistent with the present disclosure, a system for carbon storage may include a memory and one or more processors. In at least one embodiment, the one or more processors may be configured to cause the apparatus to perform one or more steps. The steps may include constructing, based on a set of facies at the targeted formation, one or more facies models based on the at least a reservoir profile and a geological profile. The steps may include refining the one or more facies models based on a facies map to output one or more refined facies models. The steps may include constructing, based on the one or more refined facies models, one or more pore space models. The steps may include comparing the one or more pore space models and the one or more refined facies models to the at least the reservoir profile and the geological profile to produce a seal map, a risk map, and a set of storage information. The steps may include identifying, based on at least one of the seal map, the risk map, and the set of storage information, a targeted location within the targeted formation, the targeted location having a set of controlling facies capable of containing supercritical carbon dioxide (CO₂).

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only example embodiments and are therefore not to be considered limiting of its scope, and may admit to other equally effective embodiments.

FIG. 1 is an example flow diagram for constructing carbon trapping mechanisms for carbon dioxide (CO₂) sequestration in facies-controlled reservoirs, according to at least one embodiment of the present disclosure.

FIG. 2 is an example flow diagram for constructing carbon trapping mechanisms for carbon dioxide (CO₂) sequestration in facies-controlled reservoirs, according to at least one embodiment of the present disclosure.

FIG. 3 is a cross-sectional view of an example clastic basin, which may be analyzed according to an aspect of the present disclosure.

FIG. 4 is a cross-sectional view of an example clastic basin, which may be analyzed according to an aspect of the present disclosure.

FIG. 5 is a cross-sectional view of an example carboniferous basin, which may be analyzed according to an aspect of the present disclosure.

FIG. 6 is a cross-sectional view of an example clastic basin, which may be analyzed according to an aspect of the present disclosure.

FIG. 7 depicts an example device that can be used to perform one or more actions according to an aspect of the present disclosure.

FIG. 8 is a block diagram of an example computer system that may be used to implement one or more of the systems or methods described herein in accordance with certain embodiments.

FIG. 9 depicts an example cloud computing environment that can be used to perform one or more actions according to an aspect of the present disclosure.

### DETAILED DESCRIPTION

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Embodiments in accordance with the present disclosure generally relate to carbon sequestration and storage technology and, more particularly, to methods and systems for constructing carbon trapping mechanisms for carbon dioxide (CO₂) sequestration in facies-controlled reservoirs.

### Example Carbon Capture and Storage

CO₂ sequestration is one component of carbon capture and storage (CCS). Carbon capture involves the separation and capture of CO₂ from the emissions of industrial processes prior to release into the atmosphere. Carbon storage involves the sequestration of CO₂ in deep underground geologic formations for short-to long-term storage. CCS enables continued industrial operation while emitting fewer greenhouse gases (CHGs) by mitigating the presence of CO₂ that would otherwise escape to the atmosphere. Ideally, formations targeted for carbon storage operations (hereinafter, targeted formation(s)) are effective to permanently sequester CO₂, environmentally sustainable, voluminous, and cost-effective. Typically, targeted formations are geological saline formations, though conventional oil and natural gas reservoirs, unconventional oil and gas reservoirs, unmineable coal seams, organic-rich shales, and basalt formations may also be targeted. Saline formations are porous formations that span large volumes deep underground. In many cases, targeted formations store CO₂ as a supercritical fluid. In its supercritical state, CO₂ may exhibit physical properties allowing for controlled short-and long-term storage.

Sequestration of CO₂ as a super critical fluid is enabled via one or more trapping mechanisms that may be present in a targeted formation. Once injected at a targeted formation, supercritical CO₂ may tend to be more buoyant than other liquids present in the surrounding pore space. As a result, supercritical CO₂ may tend to migrate vertically and laterally through targeted formation. This tendency may warrant a trapping mechanism (e.g., an impermeable seal) that disallows undesirable migration to both the surface for atmospheric release, and to lateral subsurface locations that may be contaminated by the introduction of CO₂. Trapping mechanisms may ensure that CO₂ remains underground in a targeted location at a targeted formation. The targeted location may be a location at the targeted formation that may be identified as the final subsurface storage volume for injected CO₂ (e.g., an injection site of the CO₂, a migration site connected to an injection site). A targeted location is capable of permanently containing supercritical CO₂ at the subsurface. Trapping mechanisms may include structural trapping, residual trapping, solubility trapping, and mineral trapping, although secondary and tertiary trapping are contemplated in the scope of this disclosure.

Structural trapping may include physically trapping CO₂ at the targeted location. Structural trapping may be capable of trapping a large volume of CO₂ relative to other trapping mechanisms, and is the primary trapping mechanism utilized in many CCS schemes. Facies, faults, and areas of sediment grinding within and above the targeted location may act as seals during structural trapping, preventing injected CO₂ from escaping the targeted location. Facies are distinct bodies of rock, having characteristics distinct from adjacent bodies of rock. Characteristics may include porosity, permeability, density, mineral composition, chemical composition, coherence, compaction, sediment size, grain size, crystal size, texture, sorting, fragmentation, aggregation, isotropy, anisotropy, elasticity, ductility, compressive strength, internal pore fluid pressure, confining pressure, thermal conductivity, thermal expansion, heat generation, electrical properties, magnetic properties, and the like. The characteristics of a facies may be an observable attribute of rocks (such as their overall appearance, subsurface behavior, composition, or condition of formation). Changes in observable characteristics may indicate a change in facies. Faults are fractures in a body of rock where forces (e.g., compressional or tensional) cause relative displacement of the rocks on opposite sides of the fracture. Fractures may be planar or curved, simple or complex, and may cut across multiple facies. Faults may be considered cataclastic features. Sediment grinding (e.g., abrasion) is a cataclastic event that may create a wear feature. Sediment grinding is a geological process where rocks and sediments wear away surfaces by rubbing against each other. It may as wind, water, ice, or the like rush over rocks, causing rough and jagged edges to break off, resulting in smaller grains, a higher degree of sorting, and a higher degree of smoothing. The collision, breaking, and grinding of rocks by the movement of fluids contribute to mechanical weathering, leading to the breakdown of rocks into smaller pieces. The wear features associated with sediment grinding may have lower permeability than surrounding areas within a formation, making them a potential seal for carbon storage. Facies, faults, and wear feature characteristics at a targeted location may be evaluated when identifying a proper seal for structural trapping.

Residual trapping may include physically trapping CO₂ in pore spaces between the rock grains as a CO₂ plume migrates upward over time. Porous facies may exist as sponges, trapping supercritical CO₂ in pore spaces that act as small seals. Individual pore spaces may be on micro- or nano-meter scales, but may be effective to permanently retain some non-trivial volume of supercritical CO₂ disconnected from a larger CO₂ plume. Solubility trapping may include dissolving a portion of injected CO₂ into brine water that may be present in pore spaces between the rock grains of a targeted location. At the interface formed at the contact point between supercritical CO₂ and brine water, some of the CO₂ molecules may dissolve into the brine water within the rock's pore space. Some dissolved CO₂ may then combine with available hydrogen atoms to form HCO₃₋. Mineral trapping may include a reaction that may occur when the CO₂ dissolved in the rock's brine water reacts with the minerals in the rock. When CO₂ dissolves in water it may form a weak carbonic acid (H₂CO₃) and eventually a bicarbonate (HCO₃₋). Over extended periods, this weak acid can react with the minerals in the surrounding rock to form solid carbonate minerals, permanently trapping and storing that portion of the injected CO₂ in a mineral matrix.

Targeted formations for long-term carbon storage may be evaluated for storage resource availability, injectivity, integrity, and depth. In some cases, a targeted location may include one or more targeted formations, or may be a portion of a single targeted formation. Every targeted location may have at least one, or usually multiple, regionally continuous sealing formations called caprocks or seals. Ideally, the targeted location has sufficient storage resource (space) to contain large amounts (millions of metric tons) of compressed CO₂. The injectivity of a targeted location may be directly related to the permeability of the formation. The permeability of a formation is a measure of the resistance to fluid flow through it. If fluid can easily pass through the formation, it has “high permeability.” The integrity of the targeted location is evaluated based on the targeted location's ability to confine CO₂ safely within a predetermined volume and without a breach. The targeted location may have one or more confining zones that seal above the injected formation that are intact and do not have leakage pathways. The targeted location may be located at a sufficient depth and pressure so that CO₂ can be injected as a supercritical fluid.

In the current state of the art, CCS may be performed on an “open aquifer” or a “closed aquifer”. During a CCS procedure applied to an open aquifer, structural trapping is not the primary mechanism for storing carbon. Instead trapping mechanisms dependent on gravity, density settling, and CO₂ dissolution is prioritized (e.g., residual trapping, dissolution trapping, mineral trapping). An open aquifer useful for storing carbon may have high salinity reservoirs and may have reservoirs with greater-than-average porosity and greater-than-average permeability. In some cases, an open aquifer used for CCS may have horizontal/shallow dipping reservoir geomorphology or topography. Under these conditions, migration of fluid may be slow (e.g., little or no aquifer drive toward the surface) if inclination is low. Conversely, migration of fluid may be fast where an open aquifer has higher inclination. In some cases, an open aquifer may have low or no CO₂ dissolution, which may be associated with certain plume formations having slow lateral movement below a top seal. Because open aquifer systems do not use structural trapping mechanisms, open aquifers may be likely to leak, especially where numerous faults are present at a targeted location for an open aquifer system. This may result in issues including, among other things, ecological damage associated with a CO₂ leak. For example, continuous and long-term CO₂ migration resulting after injection into an open aquifer system may pollute drinking water sources and may damage agricultural products.

During a CCS procedure applied to a closed aquifer, structural trapping is the primary mechanism for storing carbon. A closed aquifer useful for storing carbon may utilize a structural trap (e.g., a 4-way facies closure or fault closure). In some cases, an open aquifer used for CCS may have brackish-to-high salinity reservoirs, may have reservoirs with greater-than-average porosity and greater-than-average injectivity potential. In some cases, an open aquifer used for CCS may not have sensitivities to geomorphology. CO₂ migration in a closed aquifer system may be controlled by pressure, capacity, and storage efficiency. CO₂ dissolution in a closed aquifer system may be dependent on salinity (e.g., allowing for residual trapping). In some cases, a plume will form in the trap associated with the plume formation and will be more effectively stored where the top seal is structurally sound (i.e., having facies with less-than-average permeability, having minimal fault structures).

A closed aquifer system may mitigate issues that are associated with leaking an open aquifer system, including mitigating the extensive ecological damage described above. However, some closed aquifer systems may still be unable to mitigate ecological damage associated with CO₂ leakage over long period of time. In some cases, the pressure from continuous CO₂ injection may exceed a fracture gradient of seal at a targeted location, unexpectedly creating faults at the seal that may allow CO₂ to escape the targeted location. In some cases, traditional techniques for targeted formation selection do not fully account for facies characteristics, salinity, basin geometry, geomorphology, topology and the like, which may cause CO₂ to be stored in an aquifer system improper for long-term storage. Additionally, closed-aquifer systems are rare, and may not be widely available for high-volume carbon storage.

### Aspects Related to Facies-Controlled Carbon Storage

Aspects of the present disclosure provide methods and systems for characterizing and selecting a facies-controlled aquifer system for carbon storage. According to at least one embodiment, methods described herein may be applied to characterize and select a hyper-saline, semi-saline, brackish, or fresh-water aquifer carbon storage formation. When a facies-controlled aquifer is properly characterized and selected for carbon storage according to aspects described herein, migration of supercritical CO₂ may be very slow (e.g., little to no aquifer drive). The facies variation in CCS may have a profound impact on the impact of saline aquifer injection. Accordingly, robust knowledge of a facies-controlled reservoir is useful to identify each portion of a targeted formation that may support facies-controlled CO₂ injection. Thus, implementing methods and systems described herein may significantly mitigate the risk of CO₂ leakage, while also allowing more effective and voluminous CO₂ storages at a targeted, facies-controlled reservoir. Implementation of the methods described herein may also allow wider industrial exploration of potential CCS reservoirs.

In at least one embodiment, the methods described herein consider geological data to characterize and identify areas of a reservoir that are “facies controlled.” Facies controlled reservoirs, which may be open- or closed-aquifer systems, are reservoirs having highly variant subsurface facies. Variant facies, which may have distinct facies characteristics, may create closed-system geological complexes by way of chemical, mineral, residual, and/or gravity/density settling/dissolution trapping. In one example, a facies suitable for both dissolution and mineral trapping may be surrounded by facies, faults, or wear features with low permeability characteristics associated with a cap rock, thus making it a suitable structural trap. In at least one embodiment, the methods described herein consider different basin geometries, inclination values, geomorphology, and/or topography. In at least one embodiment, the methods described herein consider reservoir characteristics pertaining to a state of being permeable, semi-permeable, and/or impermeable at different points within a formation.

In at least one embodiment of the present disclosure, methods and systems for characterizing and selecting a facies-controlled reservoir include using collected reservoir/seismic information (e.g., structural maps, time-depth maps, well-ties, and the like) alongside collected geomorphological information (e.g., stratigraphic maps, depositional environment maps, well correlations, and the like) to construct a set of complex subsurface models of a potential targeted formation. A facies-controlled reservoir may be considered any reservoir having varying permeability such that fluid flow in the reservoir may be contained within the reservoir. Varying permeability may occur on account of facies changes, faults, wear features, cataclastic features, and the like. The complex subsurface models may be iteratively refined using depth-converted information and facies map information. Ultimately, the models may isolate facies-controlled complexes that may be selected for carbon storage.

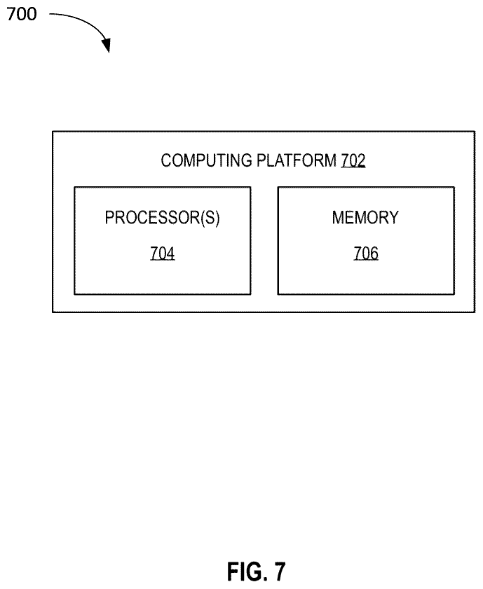

Because potential targeted reservoirs are complex, aspects of the present disclosure may utilize computers and/or their components (e.g., a memory, one or more processors) to execute characterization and selection procedures for selecting a facies-controlled reservoir for carbon storage. Further discussion of the use of a computer system or device to perform aspects of the present disclosure may be found with respect to the discussion of FIGS. 7-9.

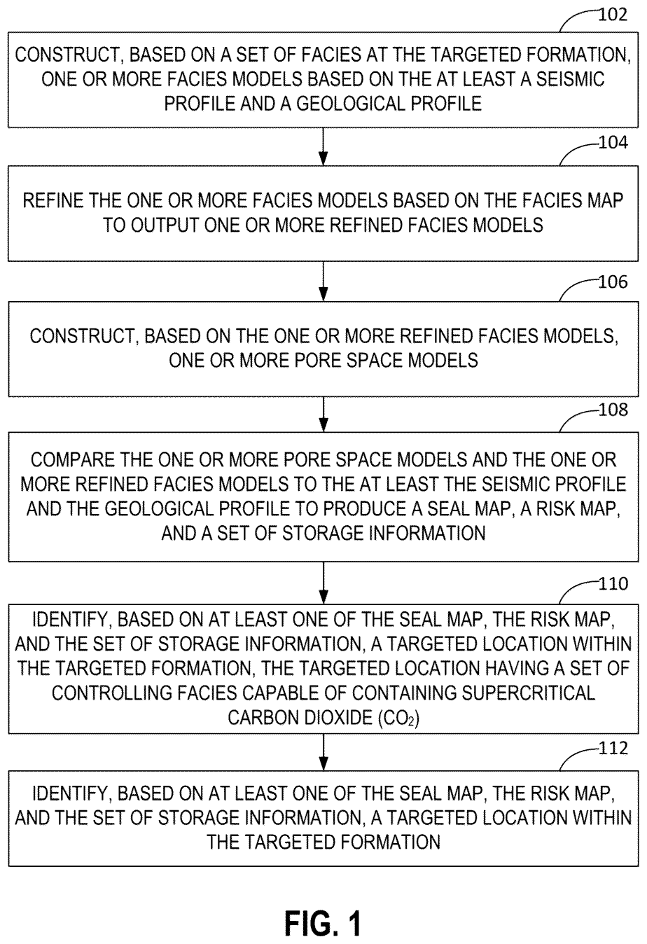

FIG. 1 provides a flow diagram that illustrates an example method for characterizing and selecting a facies-controlled reservoir. The method of FIG. 1 may be performed by a system having one or more computer components. FIG. 1 may be implemented by a computer device or system, as illustrated in FIGS. 7-9. Thus, reference can be made to the example of FIGS. 7-9 in the example of FIG. 1. The method of FIG. 1 may begin at 102 by a system constructing, based on a set of facies at the targeted formation, one or more facies models based on at least a reservoir profile and a geological profile. In at least one embodiment, the reservoir profile may be a seismic profile. In at least one embodiment, the reservoir profile may be generated by one or more processors to represent a geophysical profile of a targeted formation using seismic data collected from the targeted formation. In at least one embodiment, the geological profile may be generated by one or more processors to represent a geological profile of a targeted formation using reservoir and well data collected from the targeted formation. At step 104, a system may refine the one or more facies models based on a facies map to output one or more refined facies models. In at least one embodiment, refining the one or more facies models may be performed by comparing the one or more facies models to a facies map generated from the geological data and adjusting the one or more facies models. At step 106, a system may construct, based on the one or more refined facies models, one or more pore space models. In at least one embodiment, the pore space models may reflect porosity information and permeability information for the targeted formation that is subject of the one or more refined facies models. The permeability and porosity information may capture variant porosity and permeability within a targeted formation and may highlight facies interfaces where porosity and permeability characteristics may change to indicate a facies-controlled environment.

At step 108, a system may compare the one or more pore space models and the one or more refined facies models to the at least the reservoir profile and the geological profile to produce a seal map, a risk map, and a set of storage information. In at least one embodiment, the comparison may highlight, as above, interfaces where geological characteristics may change to indicate a facies-controlled environment. In one example, the seal map may provide a two-dimensional (2D) or three-dimensional (3D) map of facies that may be capable of sealing supercritical CO₂ in a formation on a long-term basis. In one example, the risk may provide a 2D or 3D map of faults that may currently exist or may be created through high-pressure fracturing, through which supercritical CO₂ may escape. In one example, storage information may include storage capacity for incoming CO₂, potential injection rate, saturation of the formation with incompressible fluid, and the like. At 110, a system may identify, based on at least one of the seal map, the risk map, and the set of storage information, a targeted location within the targeted formation, the targeted location having a set of controlling facies capable of containing supercritical carbon dioxide CO₂.

In at least one embodiment, the reservoir profile data may include seismic quality control data, the seismic structural data, the time-depth data, the seismic well-tie data, the depth conversion data, and the check shot data. In at least one embodiment, the geological profile may include quality control data, stratigraphy data, gross depositional map data, lithostratigraphic well correlation data, petrophysical analysis data, porosity and permeability data, and facies log data.

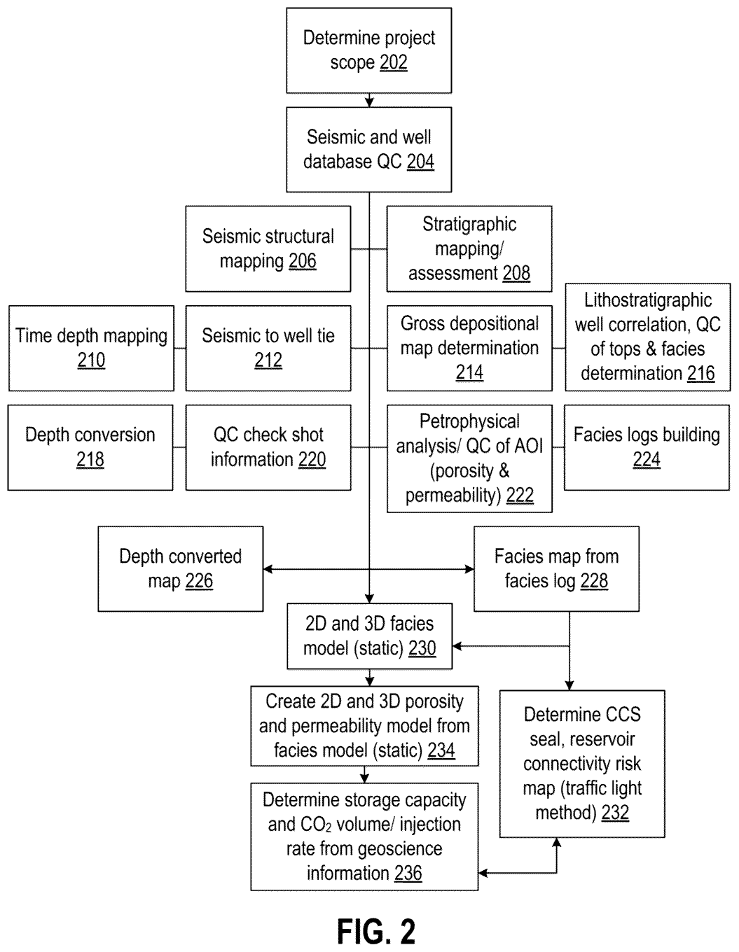

FIG. 2 provides a schematic diagram illustrating an example method for characterizing and selecting a facies-controlled reservoir. The method of FIG. 1 may be performed by a system having one or more computer components. FIG. 2 may be implemented by a computer device or system, as illustrated in FIGS. 7-9. The method of FIG. 2 may be implemented in conjunction with or independent from the method of FIG. 1. The method of FIG. 2 may begin at step 202 by determining the scope of a carbon storage project. In at least one embodiment, determining the scope may include using a system to identify and/or isolate one or more formations within a geological region. In at least one embodiment, determining the scope may include selection of a targeted formation by one or more users. At step 204, seismic and well quality control data are obtained for the targeted formation that is within the scope of the project. In at least one embodiment, seismic and well quality data may obtained from an external data base and imported into a computer system or computer device, such as the system described herein. In at least one embodiment, seismic and well quality data may be obtained from an internal data base within the system. At step 206, seismic structural mapping data may be obtained from a database or generated from seismic quality control data. At step 208, stratigraphic mapping/assessment data may be obtained from a database or generated from well quality control data. At step 210, a time depth mapping for the targeted location may be obtained from a database or generated from at least one of seismic quality control data, seismic structural mapping data, and the like. At step 212, a seismic to well tic data for the targeted location may be obtained from a database or generated from at least one of seismic quality control data, seismic structural mapping data, time depth mapping, and the like. At step 214, a gross depositional map determination data for the targeted location may be obtained from a database or generated from at least one of well quality control data, stratigraphic mapping/assessment, and the like. At step 216, lithostratigraphic well correlation data, quality control of tops data, and facies determination data for the targeted location may be obtained from a database or generated from at least one of well quality control data, stratigraphic mapping/assessment, gross depositional map determination data, and the like. At step 218, a depth conversion information for the targeted location may be obtained from a database or generated from at least one of seismic quality control data, seismic structural mapping data, time depth mapping, seismic to well tic data, and the like. At step 220, a quality control check shot information for the targeted location may be obtained from a database or generated from at least one of seismic quality control data, seismic structural mapping data, time depth mapping, seismic to well tie data, depth conversion information and the like. At step 222, petrophysical analysis data and quality control information data for the targeted location may be obtained from a database or generated from at least one of well quality control data, stratigraphic mapping/assessment, gross depositional map determination data, lithostratigraphic well correlation data, quality control of tops data, facies determination data, and the like. At step 224, facies logs building data for the targeted location may be obtained from a database or generated from at least one of well quality control data, stratigraphic mapping/assessment, gross depositional map determination data, lithostratigraphic well correlation data, quality control of tops data, facies determination data, petrophysical analysis, quality control information, and the like.

In some embodiments, each of steps 206 through 224 may be performed in parallel or in sequence. Where the steps are performed in sequence, they may be performed in any order that may produce an optimal information package for subsequent steps of the method of FIG. 2. By way of example, output from step 206 may be input for step 208, output for step 210 may me input for step 220, etc.

At step 226, the information package output from steps 204-224 is used to construct a depth converted map. At step 228, the information package output from steps 204-224 is used to construct a facies map. At step 230, any combination of the information package output from steps 204-224, the depth converted map, and the facies map, may be used to construct at least one facies model. In at least one embodiment, the facies model may be a 2D model, a 3D model, or both. In at least one embodiment, the at least one facies model is static. In at least one embodiment, the at least one facies model is a representative rendering of facies within the targeted formation, which may be used to evaluate the targeted formation to select a targeted location. At step 232, information regarding a CCS seal and information regarding the reservoir connectivity risk map associated with the targeted formation may be independently obtained. In at least one embodiment, information regarding a CCS seal and information regarding the reservoir connectivity risk map associated with the targeted formation may be obtained from an external database and correlated with information output from the method of FIG. 2. In at least one embodiment, the reservoir connectivity risk map may be constructed using a traffic light method. At step 234, at least one pore space model may be constructed based on the at least one facies model. In at least one embodiment, the at least one pore space model may be constructed based on the information package output from steps 204-224 in addition to the at least one facies model. In at least one embodiment, the at least one pore space model includes porosity and permeability information, which may include porosity and permeability models. In at least one embodiment, the at least one pore space model is 2D, 3D, or both. In at least one embodiment, the at least one pore space model is static. At step 236, storage capacity values, CO₂, volume values, and an injection rate value for a targeted formation are determined. In at least one embodiment, determining the storage capacity values, CO₂, volume values, and an injection rate value for a targeted formation may be based on output from any of steps 204-234.

Implementation of the methods of FIGS. 1 and 2 may facilitate the integration and calibration of facies, gross depositional environment, porosity, permeability, and salinity data to determine trap mechanism type in a targeted formation. Methods of FIGS. 1 and 2 may also facilitate categorizing a targeted formation into a play area (e.g., a targeted location) for robust, facies-controlled CO₂ sequestration. For example, implementation of such methods may allow industry users to evaluate an increased number of potential facies-controlled aquifer storages for CCS because the methods consider a variety of trapping mechanisms, as well as inclination/basin dip and varying salinity levels. This may improve existing aquifer characterization methods, which focus on open- and closed-aquifer systems, and may fail to account for reservoir factors that do not provide sufficient storage volumes and tend to create long-term CO₂ leakage issues. Additionally, it may be possible to identify large geological storage for CO₂ sequestration in the subsurface using methods described herein without intervening with the current hydrocarbon operations and fields.

Aspects of the present disclose provide methods and systems for facies-controlled aquifer as robust sequestration procedure for CO₂. The methods and systems described herein improve and enhance techniques that may be implemented as part of an “Open Aquifer System”. Specifically, methods and systems described herein demonstrate that changes in facies, together with depositional environment changes contributing to porosity and permeability variation in a reservoir, as well as basin inclination and salinity variation, may help to facilitate semi-confined and confined CO₂ sequestration storage tanks through better residual trapping, mineral trapping, chemical trapping and dissolution trapping. Techniques described herein provide better control and risk mitigation on potential CO₂ leakage by determining areas with poor facies, which in some cases may act as baffles to CO₂ fluid flow or leakage points. Implementations of methods and techniques described herein may facilitate high-quality CO₂ storage in targeted formation that are not geomorphologically flat basins, but still mitigate CO₂ migration by way of gravity and/or buoyancy movement. In at least one embodiment, this may be achieved by identifying and predicting facies with targeted porosity and permeability values at the reservoir. This may allow enhanced industry operation by facilitating precise CO₂ injection at areas that may trap or reduce CO₂ migration up-dip.

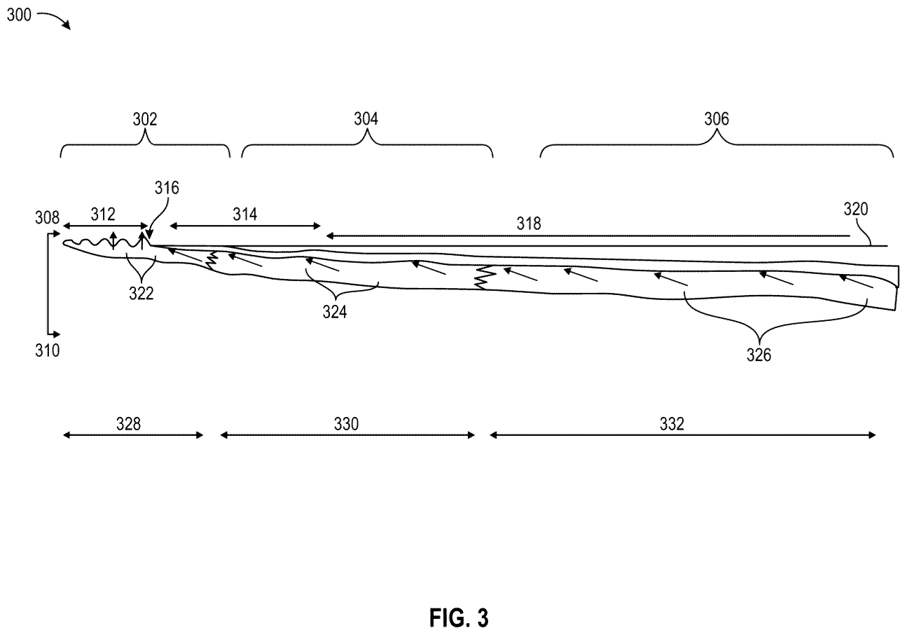

FIGS. 3-6 illustrate example targeted formations that may be explored to select targeted locations for facies-controlled CO₂ injection, according to methods described herein.

FIG. 3 illustrates an example CO₂ trapping mechanism in a facies-controlled open aquifer sag basin 300. In at least one embodiment, the basinal inclination of a sag basin is between about 0.2 degrees or more to about 1 degree or less (e.g., about 0.6 degrees), though other basinal inclination values are contemplated. In at least one embodiment, the basin 300 is a clastic Type 4 basin. Portion 302 of the basin 300 is a zone with a less-than-average risk of leakage due to a small inclination angle of the basin and the slow CO₂ movement relative to high dissolution, greater-than-average residual trapping, greater-than-average chemical trapping, and greater-than-average mineral precipitation. The portion 304 is an optimal zone for facies-controlled aquifer CO₂ storage. The portion 306 of the basin is the best zone for CO₂ injection. In at least one embodiment, portion 306 may facilitate formation of a plume and/or mega plume, followed by a slow up-dip migration to portion 304 with a possible long-tail plume formation trailing behind the meniscus of the plume. The basin 300 of FIG. 3 may range from depth 308 to depth 310. Depth 308 may be between about 2,000 feet below the surface or more to about 4,000 feet below the surface or less (e.g., 3,000 feet below the surface), though other values are contemplated. Depth 310 may be between about 9,000feet below the surface or more to about 11,000 feet below the surface or less (e.g., about 10,000 feet below the surface), though other values are contemplated. Sub-portion 312 may facilitate chemical and mineral precipitation, as well as facies changes. Sub-portion 314 may have a low risk of CO₂ leaking into ground water. In at least one embodiment, the low risk character of sub-portion 314 is facilitated by barrier 316, where greater-than-average CO₂ dissolution and residual trapping occurs. Sub-portion 318 may have reducing salinity to indicate effective facies changes. For example, salinity across the basin range from 4,000 parts-per-million (ppm) to 260,000 ppm. A portion of the sub-portion 318 closest to the surface may have salinity for about 4,000 ppm or more to about 6,500 ppm (e.g., about 5,500 ppm), though other values are contemplated. A portion of the sub-portion 318 farther to the surface may have salinity for about 200,000 ppm or more to about 260,000 ppm (e.g., about 240,000 ppm), though other values are contemplated. The basin 300 follows a mean sea level depth 320.

In at least one embodiment, areas 322 are targeted for chemical/residual/dissolution trapping. Areas 324 are targeted from residual and dissolution trapping. Areas 326 are targeted for zone of gravity/dissolution trapping. At portion 328, the basin 300 has poor reservoir facies and no connectivity. In at least one embodiment, the permeability in portion 328 is between about 0 mD or more to about 1 mD or less (e.g., between about 0 mD or more to about 0.5 mD or less), though other values are contemplated. In at least one embodiment, formation 328 may form up-dip trapping mechanisms due to shaling-out of the basin 300 and due to chemical precipitation. At portion 330, the basin 300 has fair to good reservoir quality and fair to good connectivity. In at least one embodiment, the permeability in portion 330 is between about 0.3 mD or more to about 7 mD or less (e.g., between about 0.mD or more to about 5 mD or less), though other values are contemplated. In at least one embodiment, there may be fluid resistance to movement due to tight, grain-to-grain contact in pore space, slow-down of fluid migration, residual trapping, and mineral trapping with CO₂ dissolution from a reduction of formation salinity. At portion 332, the basin 300 has excellent reservoir quality and excellent connectivity. In at least one embodiment, the permeability in portion 332 is between about 3 mD or more (e.g., about 5 mD or more), though other values are contemplated. In at least one embodiment, there is not fluid resistance to movement in portion 332 due to better grain-to-grain contact in pore space, faster fluid migration due to basin dip and good reservoir connectivity, residual trapping, and mineral trapping with CO₂ dissolution due to reduction in water. In at least one embodiment, the rate of CO₂ migration is slower in basin 300, and may not be able to migrate beyond the targeted location(s). Factors that contribute to the long-term containment of CO₂ in the basin include facies changes, mineral and chemical precipitation, residual trapping, and faster and more efficient CO₂ dissolution due to more time spent in pore space.

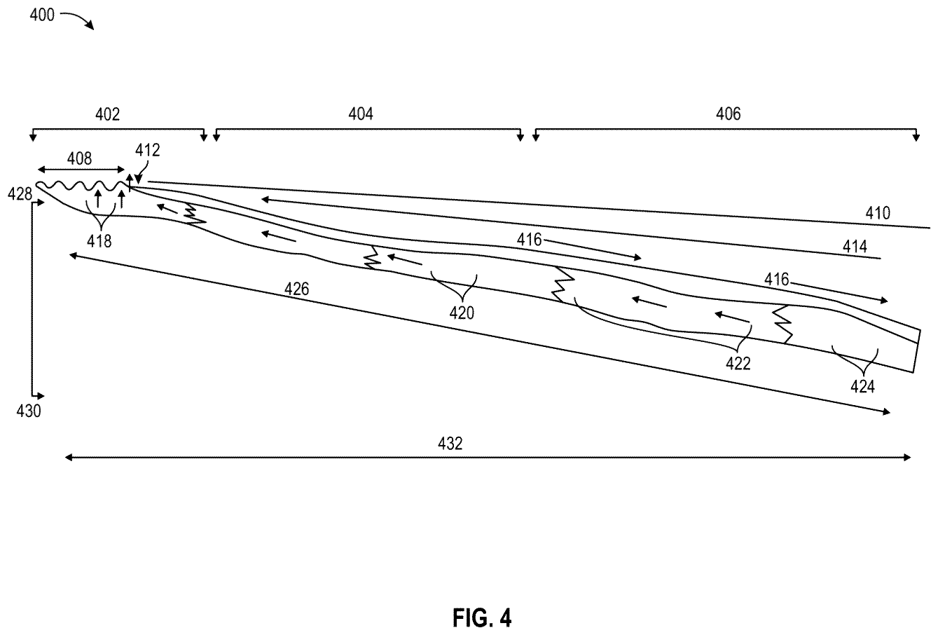

FIG. 4 illustrates an example CO₂ trapping mechanism in a facies-controlled open aquifer incline basin 400. In at least one embodiment, the basinal inclination of a basin 400 is between about 0.2 degrees or more to about 4 degree or less (e.g., between about 0.5 degrees or more to about 2 degrees or less), though other basinal inclination values are contemplated. In at least one embodiment, the basin 400 is a clastic Type 2 basin. Portion 402 of basin 400 includes a zone with a greater-than-average risk of leakage with no top seal or lateral seal. Portion 404 of basin 400 includes a zone with a greater-than-average amount of dissolution and dispersion. Portion 406 includes an open aquifer zone for CO₂ injection. A sea-level mean value may occur at geodetic plane 410. Sub-portion 408 includes fewer chemical precipitation and facies changes. Sub-portion 414 includes a depositional basin with an inclination of about 0.2 degrees or more to about 4 degree or less (e.g., between about 0.5 degrees or more to about 2 degrees or less), though other values are contemplated. Boundary 412 includes a connectivity point where CO₂ may be able to leak into groundwater. In at least one embodiment, this may occur because of a change in characteristic between sub-portion 408 and sub-portion 414. At areas 418, CO₂ is trapped via dissolution, residual, mineral, and chemical trapping mechanisms. At areas 420, which are in a direction 416 away from areas 418 and following the depositional dip of basin 400, CO₂ is trapped via residual trapping. At areas 422, which are in a direction 416 away from areas 420 and following the depositional dip of basin 400, CO₂ is trapped via residual trapping. At areas 424, which are in a direction 416 away from areas 422 and following the depositional dip of basin 400, CO₂ is trapped via greater-than-average residual trapping.

The basin 400 of FIG. 4 may range from depth 428 to depth 430. Depth 428 may be between about 2,000 feet below the surface or more to about 4,000 feet below the surface or less (e.g., 3,000 feet below the surface), though other values are contemplated. Depth 430 may be between about 9,000 feet below the surface or more to about 11,000 feet below the surface or less (e.g., about 10,000 feet below the surface), though other values are contemplated. For the entirety of basin 400, there is little facies variation, as well as excellent reservoir quality, connectivity, and fluid flow enhancement. In at least one embodiment, basin 400 may exhibit faster-than-average fluid migration, faster-than-average CO₂ migration via buoyancy, lesser-than-average residual and mineral trapping, and minimal dissolution. In at least one embodiment, permeability of the basin 400 is between about 3 mD or more (e.g., about 5 mD or more), though other values are contemplated. In at least one embodiment, the basin 400 facilitates minimal fluid resistance to movement due to better grain-to-grain contact in pore spaces within the basin 400. Accordingly, fluid migration may be faster due to basin dip having dip direction 416 and good reservoir connectivity, residual trapping mechanisms, residual trapping mechanisms, mineral trapping mechanisms, and minimal dissolution.

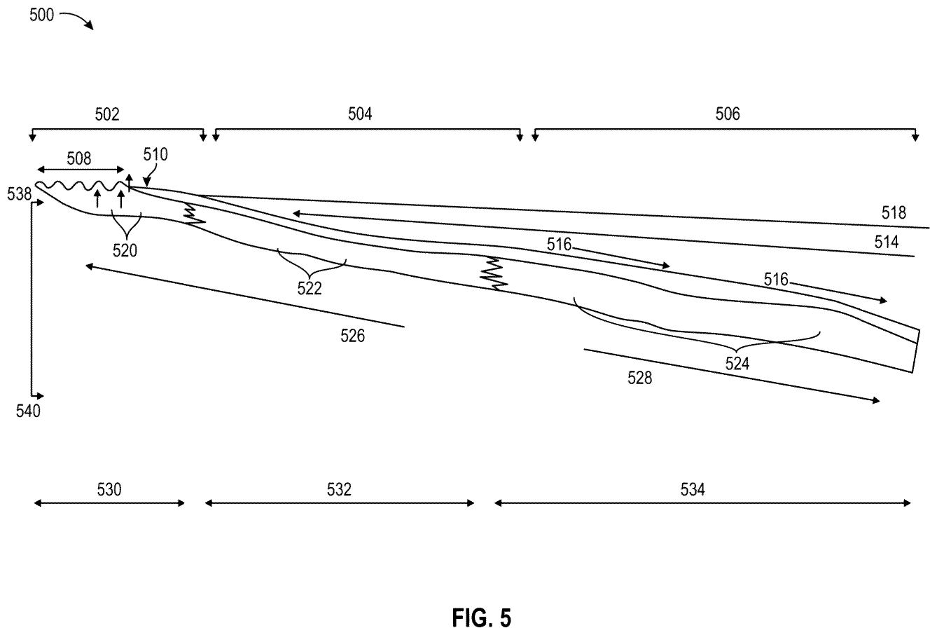

FIG. 5 illustrates an example CO₂ trapping mechanism in a facies-controlled open aquifer carboniferous basin 500. In at least one embodiment, the basinal inclination of a basin 500 is between about 0.2 degrees or more to about 4 degree or less (e.g., between about 0.5 degrees or more to about 2 degrees or less), though other basinal inclination values are contemplated. In at least one embodiment, the basin 500 is a carbonate type basin. Portion 502 of basin 500 includes a zone with a greater-than-average risk of leakage with either no top seal or a thin seal or seal breach. Portion 504 of basin 500 includes a zone with a greater-than-average effectiveness for facies controlled aquifer CO₂ injection. Portion 506 includes an zone for a 4-way structural trapping mechanism. A sea-level mean value may occur at geodetic plane 518. Sub-portion 508 includes chemical precipitation and facies changes. Sub-portion 514 includes a depositional basin with reducing salinity effective for facies changes. A portion of the sub-portion 514 closest to the surface may have salinity for about 4,000 ppm or more to about 6,500 ppm (e.g., about 5,500 ppm), though other values are contemplated. A portion of the sub-portion 514 farther to the surface may have salinity for about 200,000 ppm or more to about 260,000 ppm (e.g., about 240,000 ppm), though other values are contemplated. Boundary 510 includes a connectivity point where CO₂ may be able to leak into groundwater. In at least one embodiment, this may occur because of a change in characteristic between sub-portion 508 and sub-portion 514. At areas 520, CO₂ is trapped via dissolution, residual, mineral, and chemical trapping mechanisms. At areas 522, which are in a direction 516 away from areas 520 and following the depositional dip of basin 500, CO₂ is trapped via residual and dissolution trapping. At areas 524, which are in a direction 516 away from areas 522 and following the depositional dip of basin 500, CO₂ is trapped via zero gravity and/or residual trapping.

The basin 500 of FIG. 5 may range from depth 538 to depth 540. Depth 538 may be between about 2,000 feet below the surface or more to about 4,000 feet below the surface or less (e.g., 3,000 feet below the surface), though other values are contemplated. Depth 540 may be between about 9,000 feet below the surface or more to about 11,000 feet below the surface or less (e.g., about 10,000 feet below the surface), though other values are contemplated. For the portion 526 of basin 500, facies changes with reservoir degradation, connectivity reduction, and fluid-flow reduction. In at least one embodiment, basin 500 may exhibit slower-than-average fluid migration, lesser-than-average residual and mineral trapping, and enhanced dissolution. For the portion 528 of basin 500, there is minimal facies variation, excellent reservoir quality, excellent connectivity, and enhanced fluid flow. In at least one embodiment, basin 500 may exhibit faster-than-average fluid migration, CO₂ migration via buoyancy, lesser-than-average residual and mineral trapping, and minimal dissolution.

In at least one embodiment, the permeability in portion 530 is between about 0 mD or more to about 1 mD or less (e.g., between about 0 mD or more to about 0.5 mD or less), though other values are contemplated. In at least one embodiment, portion 530 may form up-dip trapping mechanisms due to shaling-out of the basin 500 and due to chemical precipitation. At portion 532, the basin 500 has fair to good reservoir quality and fair to good connectivity. In at least one embodiment, the permeability in portion 532 is between about 0.3 mD or more to about 7 mD or less (e.g., between about 0.mD or more to about 5 mD or less), though other values are contemplated. In at least one embodiment, there may be fluid resistance to movement due to tight, grain-to-grain contact in pore space, slow-down of fluid migration, residual trapping, and mineral trapping with CO₂ dissolution from a reduction of formation salinity. At portion 534, the basin 500 has excellent reservoir quality and excellent connectivity. In at least one embodiment, the permeability in portion 534 is between about 3 mD or more (e.g., about 5 mD or more), though other values are contemplated. In at least one embodiment, there is not fluid resistance to movement in portion 534 due to better grain-to-grain contact in pore space, faster fluid migration due to basin dip and good reservoir connectivity, residual trapping, and mineral trapping with CO₂ dissolution due to reduction in water. In at least one embodiment, the rate of CO₂ migration is slower in basin 500, and may not be able to migrate beyond the targeted location(s). Factors that contribute to the long-term containment of CO₂ in the basin include facies changes, mineral and chemical precipitation, residual trapping, and faster and more efficient CO₂ dissolution due to more time spent in pore space.

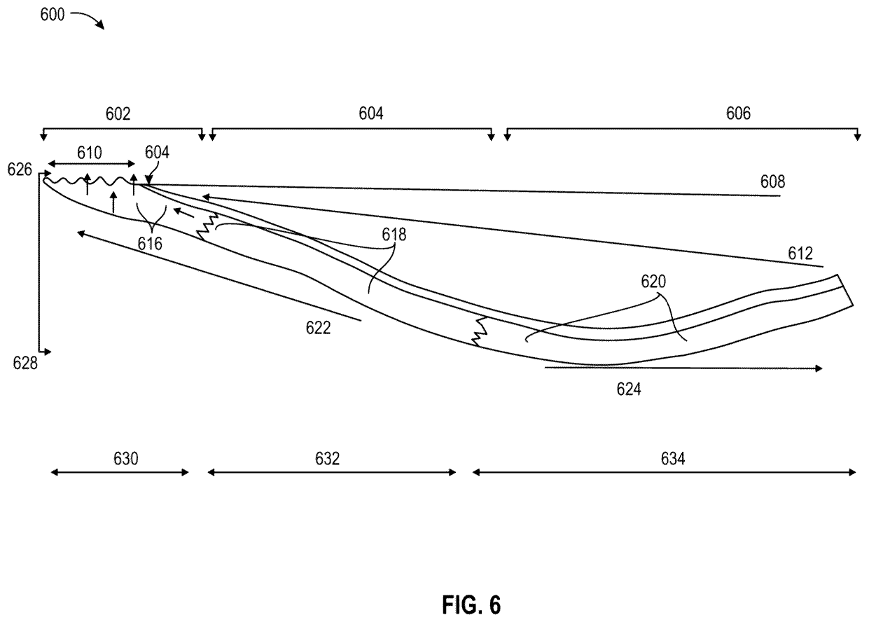

FIG. 6 illustrates an example CO₂ trapping mechanism in a facies-controlled open aquifer incline basin 600. In at least one embodiment, the basinal inclination of a basin 600 is about 1 degree or more (e.g., about 2 degrees or more), though other basinal inclination values are contemplated. In at least one embodiment, the basin 600 is a clastic type 3 type basin. Portion 602 of basin 600 includes a zone with a greater-than-average risk of leakage with either no top seal or a thin seal or seal breach. Portion 604 of basin 600 includes a zone with a greater-than-average effectiveness for facies-controlled aquifer CO₂ injection. Portion 606 includes a zone for a 4-way structural trapping mechanism. A sea-level mean value may occur at geodetic plane 608. Sub-portion 610 includes chemical precipitation and facies changes. Sub-portion 612 includes a depositional basin with reducing salinity effective for facies changes. A portion of the sub-portion 612 closest to the surface may have salinity for about 4,000 ppm or more to about 6,500 ppm (e.g., about 5,500 ppm), though other values are contemplated. A portion of the sub-portion 612 farther to the surface may have salinity for about 200,000 ppm or more to about 260,000 ppm (e.g., about 240,000 ppm), though other values are contemplated. Boundary 614 includes a connectivity point where CO₂ may be able to leak into groundwater. In at least one embodiment, this may occur because of a change in characteristic between sub-portion 610 and sub-portion 612. At areas 616, CO₂ is trapped via dissolution, residual, mineral, and chemical trapping mechanisms. At areas 618, which are downslope from areas 616, CO₂ is trapped via residual and dissolution trapping. At areas 620, which are downslope from areas 618 and following the depositional dip of basin 500, CO₂ is trapped via zero gravity and/or residual trapping. Areas 616 and 618 follow a basinal trend 622 moving from areas 618 to 616. The trend 622 includes facies change corresponding to reservoir degradation, reduction or reservoir connectivity, and reduction of fluid flow. In at least one embodiment, the trend 622 may include slower fluid migration, residual and mineral trapping, and enhanced dissolution. Areas 620 follow a basinal trend 624 moving from the end of areas 618 to areas 620. The trend 624 includes minimal facies variation, excellent reservoir quality, and enhanced fluid flow capability. In at least one embodiment, the trend 624 also includes faster-than-average fluid migration, CO₂ migration via buoyancy, minimal residual trapping, minimal mineral trapping, and minimal dissolution. The basin 600 of FIG. 6 may range from depth 626 to depth 628. Depth 626 may be between about 2,000 feet below the surface or more to about 4,000 feet below the surface or less (e.g., 3,000 feet below the surface), though other values are contemplated. Depth 628 may be between about 9,000 feet below the surface or more to about 11,000 feet below the surface or less (e.g., about 10,000 feet below the surface), though other values are contemplated.

In at least one embodiment, the permeability in portion 630 is between about 0 mD or more to about 1 mD or less (e.g., between about 0 mD or more to about 0.5 mD or less), though other values are contemplated. In at least one embodiment, portion 630 may form up-dip trapping mechanisms due to shaling-out of the basin 600 and due to chemical precipitation. At portion 632, the basin 600 has fair to good reservoir quality and fair to good connectivity. In at least one embodiment, the permeability in portion 632 is between about 0.3 mD or more to about 7 mD or less (e.g., between about 0.mD or more to about 5 mD or less), though other values are contemplated. In at least one embodiment, there may be fluid resistance to movement due to tight, grain-to-grain contact in pore space, slow-down of fluid migration, residual trapping, and mineral trapping with CO₂ dissolution from a reduction of formation salinity. At portion 634, the basin 600 has excellent reservoir quality and excellent connectivity. In at least one embodiment, the permeability in portion 634 is between about 3 mD or more (e.g., about 5 mD or more), though other values are contemplated. In at least one embodiment, there is not fluid resistance to movement in portion 634 due to better grain-to-grain contact in pore space, faster fluid migration due to basin dip and good reservoir connectivity, residual trapping, and mineral trapping with CO₂ dissolution due to reduction in water. In at least one embodiment, the rate of CO₂ migration is slower in basin 600 and may not be able to migrate beyond the targeted location(s). Factors that contribute to the long-term containment of CO₂ in the basin include facies changes, mineral and chemical precipitation, residual trapping, and faster and more efficient CO₂ dissolution due to more time spent in pore space.

### Example System and Devices for Facies-Controlled Carbon Storage

FIG. 7 is an example of a block diagram of a device for constructing carbon trapping mechanisms for carbon dioxide (CO₂) sequestration in facies-controlled reservoirs. The device can be implemented using one or more modules, shown in block form in the drawings. The one or more modules can be in software or hardware form, or a combination thereof. In some examples, the device 700 can be implemented as machine readable instructions for execution on one or more computing platforms 702 (referred to as a computing platform herein), as shown in FIG. 7. The computing platform 702 can include one or more computing systems selected from, for example, a desktop computer, a server, a controller, a blade, a mobile phone, a tablet, a laptop, a personal digital assistant (PDA), and the like.

The computing platform 704 can include a processor 704 and a memory 706. By way of example, the memory 706 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 704 can be implemented, for example, as one or more processor cores. The memory 706 can store machine-readable instructions that can be retrieved and executed by the processor 704 to implement the methods described herein. Each of the processor 704 and the memory 706 can be implemented on a similar or a different computing platform. The computing platform 702 can be implemented in a cloud computing environment (for example, as disclosed herein) and thus on a cloud infrastructure. In such a situation, features of the computing platform 702 can be representative of a single instance of hardware or multiple instances of hardware executing across the multiple of instances (e.g., distributed) of hardware (e.g., computers, routers, memory, processors, or a combination thereof). Alternatively, the computing platform 702 can be implemented on a single dedicated server or workstation.

In view of the structural and functional features described above, example methods will be better appreciated with reference to FIGS. 1-2. While, for purposes of simplicity of explanation, the example methods of FIGS. 1-2 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

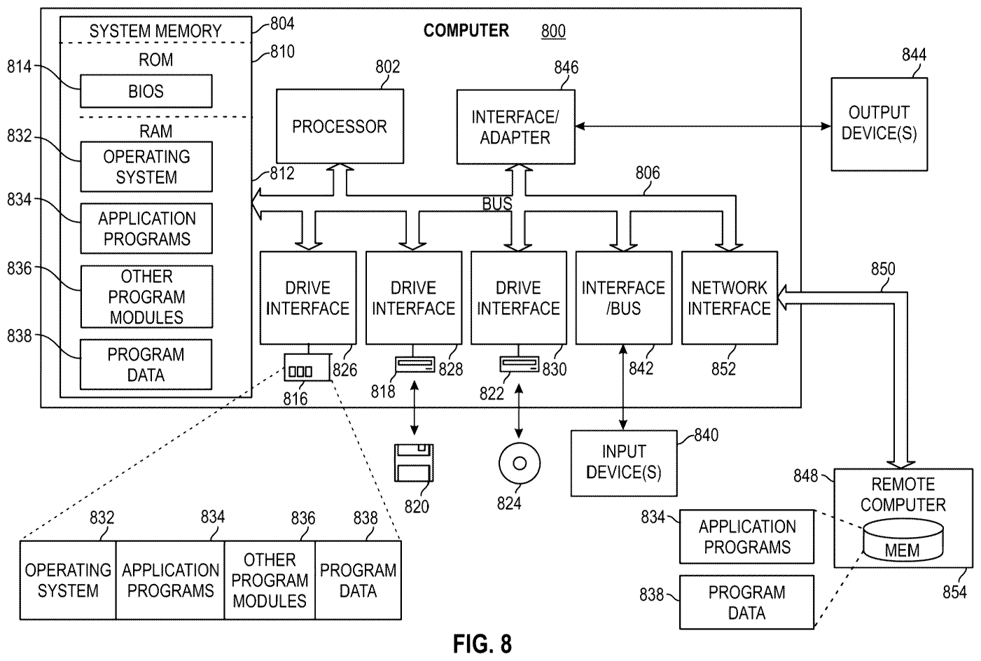

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 8. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general-purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 8 illustrates one example of a computer system 800 that can be employed to execute one or more embodiments of the present disclosure. Computer system 800 can be implemented on one or more general purpose networked computer systems, embedded computer systems, routers, switches, server devices, client devices, various intermediate devices/nodes or standalone computer systems. Additionally, computer system 800 can be implemented on various mobile clients such as, for example, a personal digital assistant (PDA), laptop computer, pager, and the like, provided it includes sufficient processing capabilities.

Computer system 800 includes processing unit 802, system memory 804, and system bus 806 that couples various system components, including the system memory 804, to processing unit 802. System memory 804 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 802. System bus 806 may be any of several types of bus structure including a memory bus or memory controller, a peripheral bus, and a local bus using any of a variety of bus architectures. System memory 804 includes read only memory (ROM) 810 and random-access memory (RAM) 812. A basic input/output system (BIOS) 814 can reside in ROM 810 containing the basic routines that help to transfer information among elements within computer system 800.

Computer system 800 can include a hard disk drive 816, magnetic disk drive 818, e.g., to read from or write to removable disk 820, and an optical disk drive 822, e.g., for reading CD-ROM disk 824 or to read from or write to other optical media. Hard disk drive 816, magnetic disk drive 818, and optical disk drive 822 are connected to system bus 806 by a hard disk drive interface 826, a magnetic disk drive interface 828, and an optical drive interface 830, respectively. The drives and associated computer-readable media provide nonvolatile storage of data, data structures, and computer-executable instructions for computer system 800. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 810, including operating system 832, one or more application programs 834, other program modules 836, and program data 838. The application programs 834 and program data 838 can include functions and methods programmed to construct carbon trapping mechanisms for CO₂ sequestration in facies-controlled reservoirs, such as shown and described herein.

A user may enter commands and information into computer system 800 through one or more input devices 840, such as a pointing device (e.g., a mouse, touch screen), keyboard, microphone, joystick, game pad, scanner, and the like. For instance, the user can employ input device 840 to edit or modify constructed carbon trapping mechanisms for CO₂ sequestration in facies-controlled reservoirs. These and other input devices 840 are often connected to processing unit 802 through a corresponding port interface 842 that is coupled to the system bus, but may be connected by other interfaces, such as a parallel port, serial port, or universal serial bus (USB). One or more output devices 844 (e.g., display, a monitor, printer, projector, or other type of displaying device) is also connected to system bus 806 via interface 846, such as a video adapter.

Computer system 800 may operate in a networked environment using logical connections to one or more remote computers, such as remote computer 848. Remote computer 848 may be a workstation, computer system, router, peer device, or other common network node, and typically includes many or all the elements described relative to computer system 800. The logical connections, schematically indicated at 850, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 800 can be connected to the local network through a network interface or adapter 852. When used in a WAN networking environment, computer system 800 can include a modem, or can be connected to a communications server on the LAN. The modem, which may be internal or external, can be connected to system bus 806 via an appropriate port interface. In a networked environment, application programs 834 or program data 838 depicted relative to computer system 800, or portions thereof, may be stored in a remote memory storage device 854.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

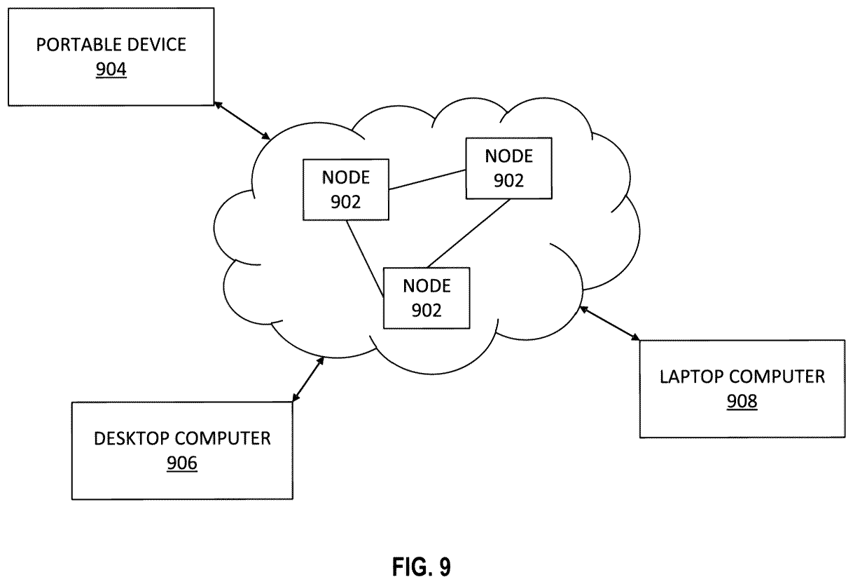

FIG. 9 is an example of a cloud computing environment 900 that can be used for implementing one or more modules and/or systems in accordance with one or more examples, as disclosed herein. Thus, reference can be made to one or more examples of FIGS. 1-8 in the example of FIG. 9. As shown, cloud computing environment 900 can include one or more cloud computing nodes 902 with which local computing devices used by cloud consumers (or users), such as, for example, personal digital assistant (PDA), cellular, or portable device 904, a desktop computer 906, and/or a laptop computer 908, may communicate. The computing nodes 902 can communicate with one another. In some examples, the computing nodes 902 can be grouped (not shown) physically or virtually, in one or more networks, such as Private, Community, Public, or Hybrid clouds, or a combination thereof. This allows the cloud computing environment 900 to offer infrastructure, platforms and/or software as services for which a cloud consumer does not need to maintain resources on a local computing device. The devices 904-908, as shown in FIG. 9, are intended to be illustrative and that computing nodes 902 and cloud computing environment 900 can communicate with any type of computerized device over any type of network and/or network addressable connection (e.g., using a web browser). In some examples, the one or more computing nodes 902 are used for implementing one or more examples disclosed herein relating to root-source identification. Thus, in some examples, the one or more computing nodes can be used to implement modules, platforms, and/or systems, as disclosed herein.

In some examples, the cloud computing environment 900 can provide one or more functional abstraction layers. It is to be understood that the cloud computing environment 900 need not provide all of the one or more functional abstraction layers (and corresponding functions and/or components), as disclosed herein. For example, the cloud computing environment 900 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 900 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 900 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 900, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 900 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 900 can provide a workloads layer that provides examples of functionality for which the cloud computing environment 900 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 900.

The present disclosure is also directed to the following exemplary embodiments, which can be practiced in any combination thereof:

A. A method for carbon storage, including: constructing, based on a set of facies at the targeted formation, one or more facies models based on the at least a reservoir profile and a geological profile; refining the one or more facies models based on a facies map to output one or more refined facies models; constructing, based on the one or more refined facies models, one or more pore space models; comparing the one or more pore space models and the one or more refined facies models to the at least the reservoir profile and the geological profile to produce a seal map, a risk map, and a set of storage information; and identifying, based on at least one of the seal map, the risk map, and the set of storage information, a targeted location within the targeted formation, the targeted location having a set of controlling facies capable of containing supercritical carbon dioxide (CO₂).

B. A system for carbon storage including a memory and one or more processors, the one or more processors configured to cause the apparatus to: construct, based on a set of facies at the targeted formation, one or more facies models based on the at least a reservoir profile and a geological profile; refine the one or more facies models based on a facies map to output one or more refined facies models; construct, based on the one or more refined facies models, one or more pore space models; compare the one or more pore space models and the one or more refined facies models to the at least the reservoir profile and the geological profile to produce a seal map, a risk map, and a set of storage information; and identify, based on at least one of the seal map, the risk map, and the set of storage information, a targeted location within the targeted formation, the targeted location having a set of controlling facies capable of containing supercritical carbon dioxide (CO₂).

Each of embodiments A through C may have one or more of the following additional elements in any combination: Element 1: identifying, based on at least one of the seal map, the risk map, and the set of storage information, a targeted location within the targeted formation; and outputting selection information based on the targeted location within the targeted formation. Element 2: selecting a targeted formation from a set of potential formations; and generating the reservoir profile and the geological profile for the targeted formation. Element 3: generating a depth-converted map and a facies map using a set of one or more parameters, the one or more parameters processed based on at least one reservoir profile of a targeted formation and at least one geological profile of the targeted formation. Element 4: the one or more facies models are two dimensional (2D) models, three dimensional (3D) models, or both; the one or more refined facies models are 2D models, 3D models, or both; and the one or more pore space models are models, 3D models, or both. Element 5: the reservoir profile further comprises at least one of: seismic quality control data, seismic structural data, time-depth data, seismic well-tie data, depth conversion data, and check shot data. Element 6: a depth-converted map for the targeted location is generated based on at least one of the seismic quality control data, the seismic structural data, the time-depth data, the seismic well-tic data, the depth conversion data, and the check shot data. Element 7: the geological profile comprises quality control data, stratigraphy data, gross depositional map data, lithostratigraphic well correlation data, petrophysical analysis data, porosity and permeability data, and facies log data. Element 8: a facies map for the targeted location is generated based on at least one of the quality control data, the stratigraphy data, the gross depositional map data, the lithostratigraphic well correlation data, the petrophysical analysis data, the porosity and permeability data, and the facies log data. Element 9: the targeted formation is a saturated saline formation.

By way of non-limiting example, exemplary combinations applicable to A through B include: Element 1 with any one of Elements 2-9; Element 2 with any one of Elements 1 and 3-9; Element 3 with any one of Elements 1-2 and 4-9; Element 4 with any one of Elements 1-3 and 5-9; Element 5 with any one of Elements 1-4 and 6-9; Element 6 with any one of Elements 1-5 and 6-9; Element 7 with any one of Elements 1-6 and 8-9; Element 8 with any one of Elements 1-7 and 9; Element 9 with any one of Elements 1-8.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method for carbon storage, comprising:
constructing, based on a set of facies at a targeted formation, one or more facies models based on at least one of a reservoir profile and a geological profile;
refining the one or more facies models based on a facies map to output one or more refined facies models;
constructing, based on the one or more refined facies models, one or more pore space models;
comparing the one or more pore space models and the one or more refined facies models to the at least one of the reservoir profile and the geological profile to produce a seal map, a risk map, and a set of storage information; and
identifying, based on at least one of the seal map, the risk map, and the set of storage information, a targeted location within the targeted formation, the targeted location having a set of controlling features capable of containing supercritical carbon dioxide (CO₂).

2. The method of claim 1, further comprising:
identifying, based on at least one of the seal map, the risk map, and the set of storage information, a targeted location within the targeted formation; and
outputting selection information based on the targeted location within the targeted formation.

3. The method of claim 3, further comprising:
selecting a targeted formation from a set of potential formations; and
generating the reservoir profile and the geological profile for the targeted formation.

4. The method of claim 1, further comprising generating a depth-converted map and a facies map using a set of one or more parameters, the one or more parameters processed based on at least one reservoir profile of a targeted formation and at least one geological profile of the targeted formation.

5. The method of claim 1, wherein:
the one or more facies models are two dimensional (2D) models, three dimensional (3D) models, or both;
the one or more refined facies models are 2D models, 3D models, or both; and
the one or more pore space models are models, 3D models, or both.

6. The method of claim 1, wherein the reservoir profile further comprises at least one of: seismic quality control data, seismic structural data, time-depth data, seismic well-tie data, depth conversion data, and check shot data.

7. The method of claim 6, wherein a depth-converted map for the targeted location is generated based on at least one of the seismic quality control data, the seismic structural data, the time-depth data, the seismic well-tie data, the depth conversion data, and the check shot data.

8. The method of claim 1, wherein the geological profile comprises quality control data, stratigraphy data, gross depositional map data, lithostratigraphic well correlation data, petrophysical analysis data, porosity and permeability data, and facies log data.

9. The method of claim 8, wherein a facies map for the targeted location is generated based on at least one of the quality control data, the stratigraphy data, the gross depositional map data, the lithostratigraphic well correlation data, the petrophysical analysis data, the porosity and permeability data, and the facies log data.

10. The method of claim 1, wherein the targeted formation is a saturated saline formation.

11. A system for carbon storage comprising a memory and one or more processors, the one or more processors configured to cause the apparatus to:
construct, based on a set of facies at a targeted formation, one or more facies models based on the at least one of a reservoir profile and a geological profile;
refine the one or more facies models based on a facies map to output one or more refined facies models;
construct, based on the one or more refined facies models, one or more pore space models;
compare the one or more pore space models and the one or more refined facies models to the at least one of the reservoir profile and the geological profile to produce a seal map, a risk map, and a set of storage information; and
identify, based on at least one of the seal map, the risk map, and the set of storage information, a targeted location within the targeted formation, the targeted location having a set of controlling features capable of containing supercritical carbon dioxide (CO₂).

12. The system of claim 11, the one or more processors are further configured to cause the apparatus to:
identify, based on at least one of the seal map, the risk map, and the set of storage information, a targeted location within the targeted formation; and
output selection information based on the targeted location within the targeted formation.

13. The system of claim 13, the one or more processors configured to cause the apparatus to:
select a targeted formation from a set of potential formations; and
generate the reservoir profile and the geological profile for the targeted formation.

14. The system of claim 11, the one or more processors configured to cause the apparatus to generate a depth-converted map and a facies map using a set of one or more parameters, the one or more parameters processed based on at least one reservoir profile of a targeted formation and at least one geological profile of the targeted formation.

15. The system of claim 11, wherein:
the one or more facies models are two dimensional (2D) models, three dimensional (3D) models, or both;
the one or more refined facies models are 2D models, 3D models, or both; and
the one or more pore space models are models, 3D models, or both.

16. The system of claim 11, wherein the reservoir profile further comprises at least one of:
seismic quality control data, seismic structural data, time-depth data, seismic well-tie data, depth conversion data, and check shot data.

17. The system of claim 16, wherein a depth-converted map for the targeted location is generated based on at least one of the seismic quality control data, the seismic structural data, the time-depth data, the seismic well-tie data, the depth conversion data, and the check shot data.

18. The system of claim 11, wherein the geological profile comprises quality control data, stratigraphy data, gross depositional map data, lithostratigraphic well correlation data, petrophysical analysis data, porosity and permeability data, and facies log data.

19. The system of claim 18, wherein a facies map for the targeted location is generated based on at least one of the quality control data, the stratigraphy data, the gross depositional map data, the lithostratigraphic well correlation data, the petrophysical analysis data, the porosity and permeability data, and the facies log data.

20. The system of claim 11, wherein the targeted formation is a saturated saline formation.
